(19) United States
(12) Patent Application Publication
(10) Pub. No.: US 2007/0070381 A1
(43) Pub. Date: Mar. 29, 2007

(54) Image forming apparatus to classify printing job and method thereof

(75) Inventor: Joo-duck Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics., Ltd., Suwon-si (KR)

(21) Appl. No.: 11/501,692

(22) Filed: Aug. 10, 2006

(30) Foreign Application Priority Data
Sep. 26, 2005 (KR) 2005-89467

(51) Int. Cl. G06F 3/12

(52) U.S. Cl. 358/1.13; 358/1.15

(57) ABSTRACT

An image forming apparatus to simply and classify a plurality of printing jobs, and a method thereof. The image forming apparatus can include a controller to transform a current printing job to a printing data to have a printing direction different from that of a prior printing job when a classifying printing option is set; and a printing unit to receive the transformed printing data and to print the received printing data.

### CROSS-REFERENCE TO RELATED APPLICATIONS

This application claims the benefit of Korean Patent Application No. 2005-89467 filed Sep. 26, 2005, in the Korean Intellectual Property Office, the disclosure of which is incorporated herein by reference in its entirety.

### BACKGROUND OF THE INVENTION

1. Field of the Invention

The present general inventive concept is related to an image forming apparatus to a printing job, and a method thereof; and more particularly, to an image forming apparatus to effectively and simply classify a plurality of printing jobs, and a method thereof.

2. Description of the Related Art

An image forming apparatus such as a copier, a printer, a scanner and a facsimile generally has a function of classifying a printing document, which is generally called a printing job. For example, several conventional methods of classifying printing jobs are being used, such as an output tray section printing, a banner page printing, an offset printing and a cross-over printing. The output tray section printing is a method of classifying printing jobs by preparing a plurality of output paper trays and outputting printing papers to one of the output paper trays according to the printing job. The banner page printing is a method of classifying a printing job by printing a printing job name, a user name or an output time on an additional page, which is a banner page, as a first page or a last page of each printing job. The offset printing is a method of classifying a printing job by outputting printing papers of each printing job to a slightly different position of a same output paper tray. The cross-over printing is a method of classifying a printing job by preparing a plurality of paper feed trays loading printing papers in different directions, and differently assigning the paper feed trays to each printing job when an printing operation is performed so that the printing papers are alternatively outputted in a length direction and a width direction to an output paper tray.

However, the conventional methods of classifying printing jobs have the following drawbacks.

The output tray section printing cannot classify the printing job when the number of output paper trays is less than the number of printing jobs to be classified. In a case where the banner page printing is used, if someone takes the banner page of one of the printing jobs, the classification of the printing jobs will be disordered. In a case where the offset printing is used, if a user checks printing contents of a printing paper by bending back the printing paper since the printing papers are outputted face down, the classification of the printing jobs by the offset printing will be disordered. Furthermore, the cross-over printing cannot be used when an image forming apparatus does not include a plurality of paper feed trays, or when an image forming apparatus does not have a function of alternatively feeding papers in the length direction and the width direction.

### SUMMARY OF THE INVENTION

Accordingly, the present general inventive concept provides an image forming apparatus to effectively and simply classify a plurality of printing jobs, and a method thereof.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept achieved by providing an image forming apparatus to classify a plurality of printing jobs, including: a controller to transform a current printing job to a printing data to have a printing direction different from that of a prior printing job when a classifying printing option is set; and a printing unit to receive the transformed printing data and print the received printing data.

The image forming apparatus may further include a storing unit to store a setting state of the classifying printing option and the printing direction of the prior printing job.

The controller may include a determining unit to determine a printing direction of the current printing job with reference to the setting state of the classifying printing option and the printing direction of the prior printing job, and a direction switching unit to transform the printing data of the current printing job.

The printing direction may be 180°.

The image forming apparatus may further include a user interface unit to provide an interface to a user to set the classifying printing option, wherein the user interface may be at least one of an operational panel having a key to set the classifying printing option and to determine whether the classifying printing option is set through the key, a web controller of a host providing a web page to set the classifying printing option and to determine whether the classifying printing option is set through the Internet, and a printer driver of a host providing a graphic user interface to set the classifying printing option to a user and to determine whether the classifying printing option is set to the controller.

The controller may include a determining unit to determine whether the classifying printing is being performed base on the setting state of the classifying printing option stored in the storing unit and the printing direction of the prior printing job, and to determine the printing direction of the current printing job, a transforming unit to transform the current printing job to the printing data having the direction different from that of the prior printing job when the classifying printing option is set, and a direction switching unit to receive the transformed printing data and to output a switching value to change the printing direction of the received printing data to be different from the printing direction of the prior printing data when the setting state of the classifying printing option is in an ON state.

The foregoing and/or other aspects and utilities of the present general inventive concept may also be achieved by providing an image forming method of classifying a printing job, including, transforming a current printing job to a printing data to have a printing direction different from that of a prior printing job when a classifying printing option is set for a printing job, and printing the transformed printing data.

The image forming method may further include storing a setting state of the classifying printing option and the printing direction of the prior printing job.

The transforming of the current printing job may include determining a printing direction of the current printing job with reference to the setting state of the classifying printing option and the printing direction of the prior printing job, and transforming the printing data of the current printing job.

The printing direction may be 180°.

The image forming method may further include providing an interface to a user to set the classifying printing option.

The providing of the interface may be at least one of setting the classifying printing option through an operating panel having a key to set the classifying printing option, set the classifying printing option through a web controller, or set the classifying printing option through a printer driver of a host.

The foregoing and/or other aspects and utilities of the present general inventive concept achieved by providing an image forming apparatus to classify printing jobs, including: a determining unit to determine whether a request to classify a printing job is set; and a classification unit to transform printing data of a current printing job 180 degrees with respect to a prior printing job and then output the transformed printing data if it is determined that a request to classify a printing job is set, otherwise to output the printing data without transforming the printing data.

The foregoing and/or other aspects and utilities of the present general inventive concept achieved by providing an image forming method of classifying a printing job, including determining whether a request to classify a printing job is set and transforming printing data of a current printing job 180 degrees with respect to a prior printing job and then outputting the transformed printing data if it is determined that a request to classify a printing job is set, otherwise outputting the printing data without transforming the printing data.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an image forming apparatus to classify a plurality of printing jobs according to an embodiment of the present general inventive concept;

FIG. 2 is a flowchart of a method of classifying a plurality of printing jobs according to an embodiment of the present general inventive concept;

FIG. 3 is a flowchart of a method of classifying a plurality of printing jobs according to another embodiment of the present general inventive concept; and

FIGS. 4A and 4B are views illustrating printing data classified by rotating the printing direction of the printing job according to an embodiment of the present general inventive concept.

### DETAILED DESCRIPTION OF THE PREFERRED EMBODIMENTS

Certain embodiments of the present general inventive concept will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

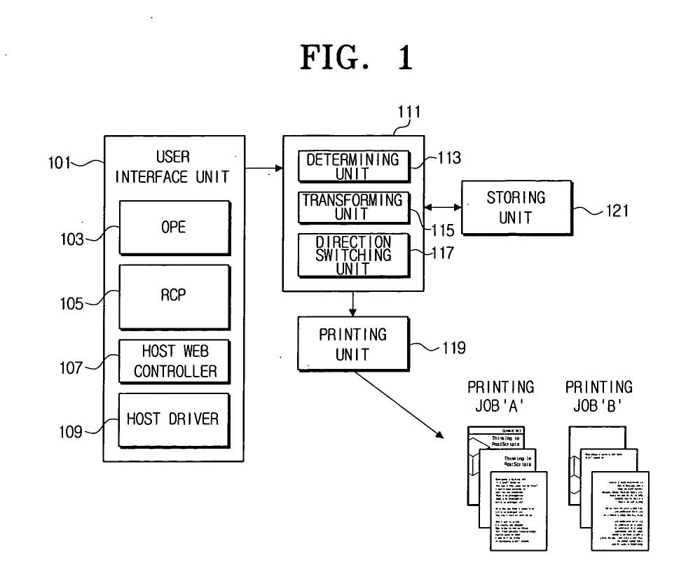

FIG. 1 is a block diagram of an image forming apparatus to classify a plurality of printing jobs according to an embodiment of the present general inventive concept.

Referring to FIG. 1, the image forming apparatus of this embodiment includes a user interface unit 101, a controller 111, a printing unit 119 and a storing unit 121.

A user sets a classifying printing option through the user interface unit 101. The classifying printing option is a function of classifying a printing job by rotating a printing direction by 180° according to a printing job when printing images on the printing paper.

The user interface unit 101 may be one of: 1) an operating panel equipment (OPE) 103 or a remote control panel (RCP) 105 having a key toset the classifying printing option and to determine whether the classifying printing option is set to the controller 111 through a wired or wireless link; 2) a host web controller 107 to provide a web-page to a user to set the classifying printing option and to determine whether the classifying printing option is set or not to the controller 111 through the Internet; and 3) a host driver 109 providing a graphic user interface (GUI) to a user to set the classification option and noticing whether the classifying printing option is set to the controller 111.

The storing unit 121 may store a state of the classifying printing option and a printing direction of a printing job set by a user through the user interface unit 101.

The stored printing direction of the printing job is a switching value. If the printing direction of the printing job is 0°, the switching value is 0, and if the printing direction of the printing job is 180°, the switching value is 1.

The controller 111 may include a determining unit 113, a transforming unit 115 and a direction switching unit 117. The transforming unit 115 may transform a current printing job to a printable data to have a different printing direction compared to that of a prior printing job.

The determining unit 113 determines whether the classifying printing is performed based on the setting state of the classifying printing option stored in the storing unit 121 and the printing direction of the prior printing job, and determines the printing direction of the current printing job.

The printable data may be a bitmap data that can be processed by a printer, which is transformed from a printing job, i.e., a postscript (PS) format data, or a printer control language (PCL) format data that is transformed by a printer driver of a host.

The direction switching unit 117 receives the transformed printing data from the transforming unit 115 and outputs a switching value to change the printing direction of the received printing data to be different from the printing direction of the prior printing data when the setting state of the classifying printing option is ON. For example, if a switching value stored in the storing unit is 0, the direction switching unit 117 outputs a 1 as the switching value for the current printing data and replaces the switching value of 0 stored in the storing unit to 1. Herein, if the printing direction is 0°, the switching value is 0, and if the printing direction is 180°, the switching value is 1.

The printing unit 119 receives the printing data and performs a printing operation of the printing data. Herein, a printing job A denotes printing pages having images formed based on a printing direction of 0° and a printing job B denotes printing pages having images formed based on a printing direction of 180°.

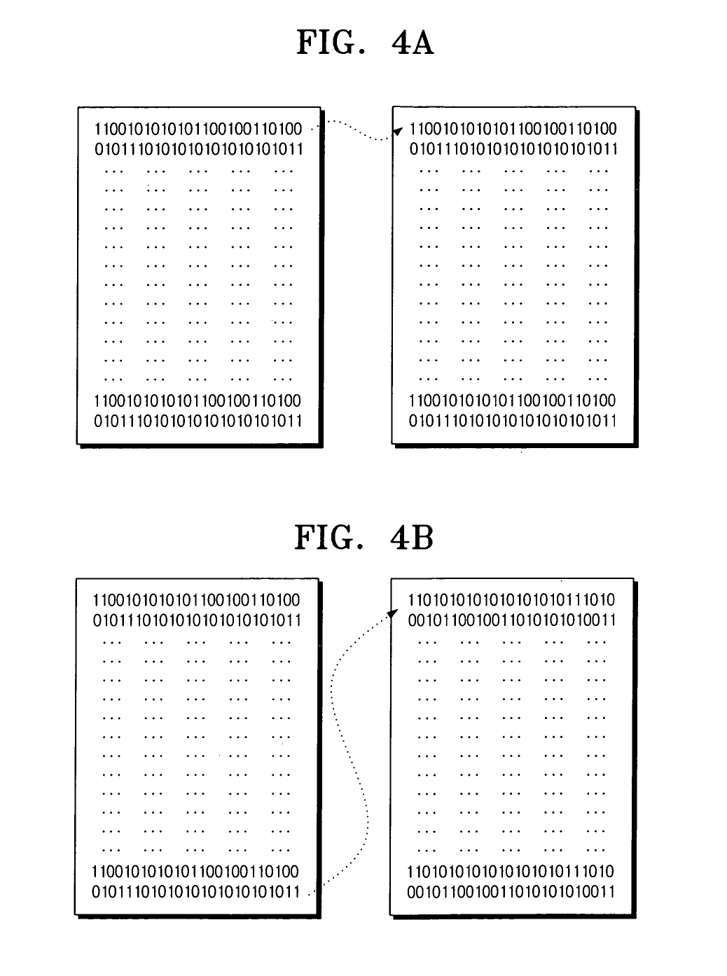

FIGS. 4A and 4B are views illustrating printing data classified by rotating the printing direction of the printing job according to an embodiment of the present general inventive concept.

FIG. 4A illustrates a method of printing the printing data with a printing direction of 0°. The direction switching unit 117 (FIG. 1) outputs the printing data from a first data to a last data of the printing data, and the printing unit 119 receives the first data from the direction switching unit 117 and prints the received data from a first line to a last line of the printing data.

FIG. 4B illustrates a method of printing a printing job with a printing direction of 180°. The direction switching unit 117 outputs the printing data from a last data to a first data of the printing data since the printing direction is rotated by 180°. Then, the printing unit 119 receives the printing data with a printing direction switched value and prints the printing data from the last line to the first line.

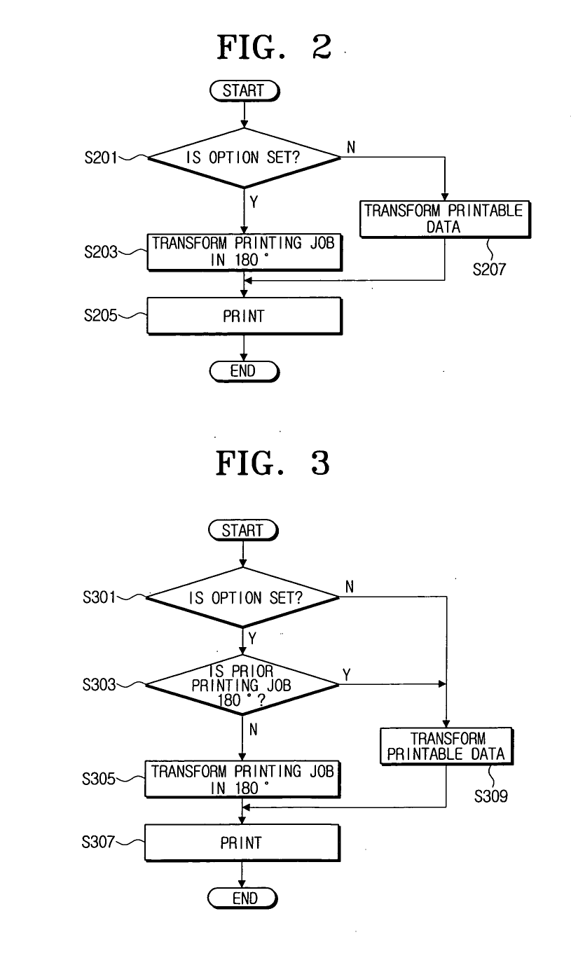

FIG. 2 is a flowchart of a method of classifying a plurality of printing jobs according to an embodiment of the present general inventive concept.

Referring to FIGS. 2 and 1, a user can set the classifying printing option through the user interface unit 101, and the setting state of the classifying printing option is stored in the storing unit 121. The controller 111 determines whether the classifying printing option is set with reference to the setting state stored in the storing unit 121 in operation S201. If the setting state of the classifying printing option is ON, that is, if the classifying printing option is set in operation S201:Y, the transforming unit 115 transforms the printing job to a printable data and then the direction switching unit 117 changes the printing direction of the printable data to 180° in operation S203. The print unit 119 receives the printable data with the changed printing direction from the controller 111 and prints the printable data in operation S205.

If the setting state of the classifying printing option is OFF in operation S201:N, the transformer 115 transforms the printing job to a printable data and then the controller 111 outputs the printable data without changing the printing direction in operation S207. In other words, the direction switching unit 117 does not change the printing direction of the printable data. The printing unit 119 receives the printable data from the controller 111 and prints the received printable data in operation S205.

FIG. 3 is a flowchart of a method of classifying a plurality of printing jobs according to another embodiment of the present general inventive concept.

Referring to FIGS. 3 and 1, a user can set the classifying printing option through the user interface unit 101 and stores the setting of the classifying printing option in the storing unit 121. The determining unit 113 of the controller 111 determines whether the classifying printing option is set based on the setting state of the classifying printing option stored in the storing unit 121, in operation S301. If the classifying printing option is ON in operation S301:Y, the determining unit 113 of the controller 111 determines whether a printing direction of a prior printing job is 180° in operation S303. If the printing direction of the prior printing job is not 180° in operation S303:N, the transforming unit 115 transforms the printing job to a printable data and then the direction switching unit 117 receives the transformed printable data and switches a printing direction of the received printable data to be 180° in operation S305. The printing unit 119 receives the printable data with 180° of the printing direction from the direction switching unit 117 and prints the printable data in operation S307. If the printing direction of the prior printing job is 180° in operation S303:Y, the printing job is transformed to the printable data by the transforming unit 115, and the printable data is outputted without changing the printing direction thereof in operation S309.

If the classifying printing option is off in operation S301:N, the transforming unit 115 of the controller 111 transforms the printing job to a printable data and the direction switching unit 117 does not change the printing direction of the printable data. Then the controller 111 outputs the printable data in operation S309. The printing engine unit 119 receives the printable data from the controller 111 and prints the received printable data in operation S307.

As described above, the image forming apparatus according to the present general inventive concept simply and effectively classifies a plurality of printing jobs. Also, the methods of classifying a plurality of printing jobs according to various embodiments of the present general inventive concept can be implemented within a firmware level. Therefore, complicated hardware configurations are not required.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus to classify a plurality of printing jobs, comprising:
a controller to transform a current printing job to a printing data to have a printing direction different from that of a prior printing job when a classifying printing option is set; and
a printing unit to receive the transformed printing data and to print the received printing data.

2. The image forming apparatus of claim 1, further comprising:
a storing unit to store a setting state of the classifying printing option and the printing direction of the prior printing job.

3. The image forming apparatus of claim 1, wherein the controller includes:
a determining unit to determine a printing direction of the current printing job with reference to the setting state of the classifying printing option and the printing direction of the prior printing job; and
a direction switching unit to transform the printing data of the current printing job.

4. The image forming apparatus of claim 1, wherein the printing direction is 180°.

5. The image forming apparatus of claim 1, further comprising:
a user interface unit to provide an interface to a user to set the classifying printing option,
wherein the user interface is at least one of an operational panel having a key to set the classifying printing option and to determine whether the classifying printing option is set through the key, a web controller of a host to provide a web page to set the classifying printing option and to determine whether the classifying printing option is set through the Internet, and a printer driver of a host to provide a graphic user interface to set the classifying printing option to a user and to determine whether the classifying printing option is set to the controller.

6. The image forming apparatus of claim 2, wherein the controller comprises:
a determining unit to determine whether the classifying printing is being performed base on the setting state of the classifying printing option stored in the storing unit and the printing direction of the prior printing job, and to determine the printing direction of the current printing job;
a transforming unit to transform the current printing job to the printing data having the direction different from that of the prior printing job when the classifying printing option is set; and
a direction switching unit to receive the transformed printing data and to output a switching value to change the printing direction of the received printing data to be different from the printing direction of the prior printing data when the setting state of the classifying printing option is in an ON state.

7. An image forming apparatus to classify printing jobs, comprising:
a determining unit to determine whether a request to classify a printing job is set; and
a classification unit to transform printing data of a current printing job 180 degrees with respect to a prior printing job and then output the transformed printing data if it is determined that a request to classify a printing job is set, otherwise to output the printing data without transforming the printing data.

8. The image forming apparatus of claim 7, further comprising:
a printing unit to receive and print the output printing data.

9. An image forming method of classifying a printing job, comprising:
transforming a current printing job to a printing data to have a printing direction different from that of a prior printing job when a classifying printing option is set for a printing job; and
printing the transformed printing data.

10. The image forming method of claim 9, further comprising:
storing a setting state of the classifying printing option and the printing direction of the prior printing job.

11. The image forming method of claim 9, wherein the transforming of the current printing job includes:
determining a printing direction of the current printing job with reference to the setting state of the classifying printing option and the printing direction of the prior printing job; and
transforming the printing data of the current printing job.

12. The image forming method of claim 9, wherein the printing direction is 180°.

13. The image forming method of claim 9, further comprising:
providing an interface to a user to set the classifying printing option.

14. The image forming method of claim 13, wherein the providing of the interface is at least one of setting the classifying printing option through an operating panel having a key to set the classifying printing option, setting the classifying printing option through a web controller, or setting the classifying printing option through a printer driver of a host.

15. An image forming method of classifying a printing job, comprising:
determining whether a request to classify a printing job is set; and
transforming printing data of a current printing job 180 degrees with respect to a prior printing job and then outputting the transformed printing data if it is determined that a request to classify a printing job is set, otherwise outputting the printing data without transforming the printing data.
